(19) United States
(12) Patent Application Publication
(10) Pub. No.: US 2011/0153443 A1
(43) Pub. Date: Jun. 23, 2011

(54) SYSTEM AND METHOD FOR PROVIDING AUTOMATIC GENERATION OF AN ACCESS SERVICE REQUEST

(75) Inventors: Lakshmi NRUSIMHAN N. V., Chennai (IN); Priyanka G. SRIRAGHAVAN, Chennai (IN)

(73) Assignee: VERIZON PATENT AND LICENSING, INC., Basking Ridge, NJ (US)

(21) Appl. No.: 12/640,330

(22) Filed: Dec. 17, 2009

(51) Int. Cl. G06Q 30/00; G06Q 50/00; G06F 17/00

(52) U.S. Cl. 705/26.1; 715/226

(57) ABSTRACT

A system and method for providing automatic generation of a access service request is disclosed. The system may comprise a front-end module configured to receive data associated with an order for a telecommunications service. A request generation interface may be provided to determine at least a service provider and a telecommunications service associated with the order. The request generation interface may also be configured to find a one or more matching templates in a list of templates stored in at least one data storage unit, apply the one or more matching templates to the order, and generate a access service request. A template module may be provided to generate at least one template based on the determination and match at the request generation interface. A business rules module may be provided to apply one or more business rules when generating the access service request. A back-end module may be provided to transmit the access service request to the service provider for ordering the telecommunications service.

### BACKGROUND INFORMATION

Access service requests (“ASRs”) are the most widely accepted methods for ordering broadband and voice circuits. ASRs enable broadband service providers to offer a set of service bundles to customers. However, ordering ASRs is typically an arduous, error-prone process that requires specific programming or coding knowledge and involves numerous forms and ever-changing business rules.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts a block diagram of a system architecture for providing communications service, according to an exemplary embodiment.

FIG. 2 depicts a block diagram of a system architecture for providing an automatic generation of a service request, according to an exemplary embodiment.

FIG. 3 depicts a table with illustrative symbols for providing an automatic generation of a service request, according to an exemplary embodiment.

FIG. 4 depicts an illustrative flowchart of a method for providing an automatic generation of a service request, according to another exemplary embodiment.

FIGS. 5A-5C depict illustrative screens for providing an automatic generation of a service request, according to another exemplary embodiment.

### DETAILED DESCRIPTION OF EMBODIMENTS

Reference will now be made in detail to exemplary embodiments, examples of which are illustrated in the accompanying drawings. It should be appreciated that the same reference numbers will be used throughout the drawings to refer to the same or like parts. It should be appreciated that the following detailed description are exemplary and explanatory only and are not restrictive.

Exemplary embodiments may provide a system and method for providing an automatic generation of a service request. That is, exemplary embodiments may, among other things, expand and optimize ordering of broadband and communications service, such as Internet, telephone, or television service, by comprehensively and effectively providing automatic generation of a service request.

As discussed above, a service request (e.g., an access service request (“ASR”) or a local service request (“LSR”)) may be required for ordering service from a provider or carrier. In telecommunications, incumbent local exchange carriers (“ILECs”) may be carriers that originally lay down the communication lines in a specific geographical area and may therefore have a carrier monopoly in that area. Competitive local exchange carriers (“CLECs”) may compete with other established carriers (e.g., ILECs and other CLECs). CLECs may lease lines from an ILEC and resell these lines to Internet Service Providers (“ISPs”). In some embodiments, the provider or carrier may be an interexchange carrier (“IXC”), which is a telecommunications company for providing long-distance telephone service. An IXC carries traffic, usually voice traffic, between telephone exchanges which are identified (in the United States) by the three-digit area code (NPA) and the first three digits of the phone number (NPA-NXX). Ultimately, a service request may be required by ILECs, CLECs, and IXCs to order high-capacity circuits, such as T1 or T3 lines, optical circuits (“OCXs”), asynchronous transfer mode circuits, frame relay circuits, or other similar products or services. Service requests may also allow customers to order voice trunks from other carriers to gain access to the public switched telephone network (“PSTN”).

In some embodiments, when a CLEC wants to provide service to a customer who is in the ILEC boundary, in order to reach the customer, CLEC may need to send an ASR to an ILEC Once the CLEC sends an ASR to the ILEC, the ILEC may see if the ASR could be serviced. Preparing and handling the ASR may therefore be a very important step in service provisioning. In order to properly prepare and handle ASRs or other service requests for a particular service, one or more forms with associating fields may need to be selected and populated to order that particular service. For example, ASR 38 or ASR 39 may list all required forms for available services. Each form may have 50+ fields to fill in. Each field may be based on one or more complex business rules. As a result, ordering an ASR for a particular service may be a rather complicated process since populating the forms accurately is required in order to send the ASR to the ILEC or carrier.

According to an embodiment, one or more standard order guidelines, such as an access service order guide (“ASOG”), have been developed by Ordering and Billing Forum (“OBF”) and Alliance for Telecommunications Industry Solutions (“ATIS”) to help CLEC, IXCs, etc., order ASRs from providers. Changes to an ASOG, for example, which may occur often throughout a year, may force information technology or communications systems to frequently make code changes. As a result, complying with the latest ASR version may add additional challenges for ordering services. For example, code changes may lead to changes in business logic, new form fields (e.g., new criteria may be added, removed, modified to the ASR or LSR), changes in the format in which the ASR/LSR are to be submitted, etc. By providing a system and method with an automatic generation of an ASR, a business analyst with no programming knowledge may be able to send service requests to providers according to requirements of the ASOG, with reduced effort and time.

It should be appreciated that the term, “service request,” as used herein, may refer to any request for ordering one or more services from a service provider or carrier. For example, these may include an access service request (“ASR”), a local service request (“LSR”), or other various types of requests for ordering broadband service, voice circuits, television or cable service, or other communications or related service. Although embodiments of the present disclosure are primarily discussed with respect to ASRs, it should be appreciated that LSRs or other types of service requests may be used interchangeably as well for ordering one or more services from a service provider or carrier.

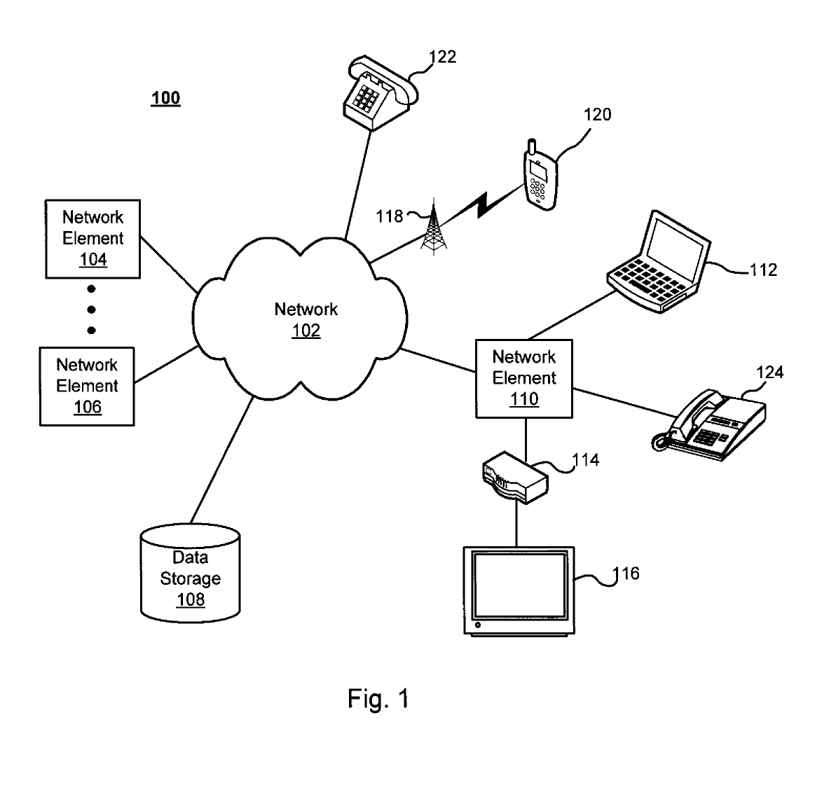

FIG. 1 depicts a block diagram of a system architecture for providing communications service, according to an exemplary embodiment. As illustrated, network 102 may be communicatively coupled with one or more devices including network element 104, network element 106, data storage 108, and network element 110. Other devices may be communicatively coupled with network 102 via one or more intermediary devices, such as transceiver 118, network element 110, or a wireline phone 122. Wireless device 120 may be communicatively coupled with network 102 via transceiver 118. Network client 112 and set-top box 114 may be communicatively coupled with network 102 via network element 110. Wireless control 110 may be communicatively coupled with set-top box 114 via infrared, Bluetooth communication, or other wireless technologies. A video display (e.g., television set 116) may be communicatively coupled to set-top box 114. It should also be appreciated that other various components may also be communicatively coupled with the network element 110, such as a Voice over Internet Protocol (“VoIP”) phone 124.

Network 102 may be a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting or receiving a data signal. In addition, network 102 may include, without limitation, telephone line, fiber optics, IEEE Ethernet 802.3, a wide area network (“WAN”), a local area network (“LAN”), or a global network such as the Internet. Also, network 102 may support, an Internet network, a wireless communication network, a cellular network, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as one network, it should be appreciated that according to one or more embodiments, network 102 may comprise a plurality of interconnected networks, such as, for example, a service provider network, the Internet, a broadcaster's network, a cable television network, corporate networks, or home networks.

Network elements 104, 106, 110, and data storage 108 may transmit and receive data to and from network 102 representing broadcast content, user request content, mobile communications data, or other data. The data may be transmitted and received utilizing a standard telecommunications protocol or a standard networking protocol. For example, one embodiment may utilize Session Initiation Protocol (“SIP”). In other embodiments, the data may be transmitted or received utilizing other Voice Over IP (“VOIP”) or messaging protocols. For example, data may also be transmitted or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 102 may use standard wireless protocols including IEEE 802.11a, 802.11b and 802.11g. Network 102 may also use protocols for a wired connection, such as an IEEE Ethernet 802.3.

Transceiver 118 may be a repeater, a microwave antenna, a cellular tower, or another network access device capable of providing connectivity between to different network mediums. Transceiver 118 may be capable of sending or receiving signals via a mobile network, a paging network, a cellular network, a satellite network or a radio network. Transceiver 118 may provide connectivity to one or more wired networks and may be capable of receiving signals on one medium such as a wired network and transmitting the received signals on a second medium, such as a wireless network.

Wireless device 120 may be a mobile communications device, wireline phone, a cellular phone, a mobile phone, a satellite phone, a personal digital assistant (“PDA”), a computer, a handheld MP3 player, a handheld multimedia device, a personal media player, a gaming device, or other devices capable of communicating with network 102 via transceiver 118.

Network elements, transceiver 118 data storage 108, and set-top box 114 may include one or more processors for recording, transmitting, receiving, or storing data. Although network elements, transceiver 118 and data storage 108 are depicted as individual elements, it should be appreciated that the contents of one or more of a network element, transceiver 118, and data storage 108 may be combined into fewer or greater numbers of devices and may be connected to additional devices not depicted in FIG. 1. Furthermore, the one or more devices may be local, remote, or a combination thereof a first network elements, transceiver 118, and data storage 108.

Data storage 108 may be network accessible storage and may be local, remote, or a combination thereof to network elements 104, 106, and 110. Data storage 108 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, Data storage 108 may be a database, such as an Oracle database, a Microsoft SQL Server database, a DB2 database, a MySQL database, a Sybase database, an object oriented database, a hierarchical database, or other database. Data storage 108 may utilize flat file structures for storage of data.

Network elements 104, 106, and 110 may be one or more servers (or server-like devices), such as a Session Initiation Protocol (“SIP”) server. Network elements 104, 106, and 110 may include one or more processors (not shown) for recording, transmitting, receiving, or storing data. According to one or more embodiments, network elements 104, 106, and 110 may be servers providing media content to one or more users. In other embodiments, network elements 104, 106, and 110 may be servers that provide network connection between two or more wireless devices 118. Network elements 104, 106, and 110 may also be servers of a service provider, the Internet, a broadcaster, a cable television network, or another media provider.

Network element 110 may be a residential gateway, such as a router, an optical network terminal or another piece of Customer Premises Equipment (“CPE”) providing access to one or more pieces of equipment. For example, network element 110 may provide audio/video programming content feeds to a set-top box, such as set-top box 116. Network element 110 may also provide network connectivity for other clients, such as a Voice Over IP (“VOW”) phone (not shown) and a network client, e.g., network client 112.

Network client 112 may be a desktop computer, a laptop computer, a server, a personal digital assistant, or other computer capable of sending or receiving network signals (e.g., CPE, a television, radio, phone, appliance, etc.). Network client 112 may use a wired or wireless connection. It should also be appreciated that the network client 112 may be a portable electronic device capable of being transported. For example, these may include a digital picture frame, an electronic reader device, or other portable device. Such a device may transmit or receive signals and store information in transit, and in the event it is transported out of the unit, the portable electronic device may still operate using the data (e.g., digital image, electronic book, etc.) it stored. Although depicted as connected via a residential gateway in FIG. 1, it should be appreciated that the network client 112 may connect directly to network 102 or via other network connectivity devices as well. According to one or more embodiments, network client 112 using a wireless connection may authenticate with a network using Wired Equivalent Privacy (“WEP”), Wi-Fi Protected Access (“WPA”), or other wireless network security standards.

System 100 may be used for mobile telecommunications between two or more components of the system 100, e.g., two or more wireless devices, wireless device with network client, set top box with wireless device, landline phone, VoIP, etc. System 100 may also be used for transmitting or receiving multimedia content. The various components of system 100 as shown in FIG. 1 may be further duplicated, combined or integrated to support various applications and platforms. Additional elements may also be implemented in the systems described above to support various applications.

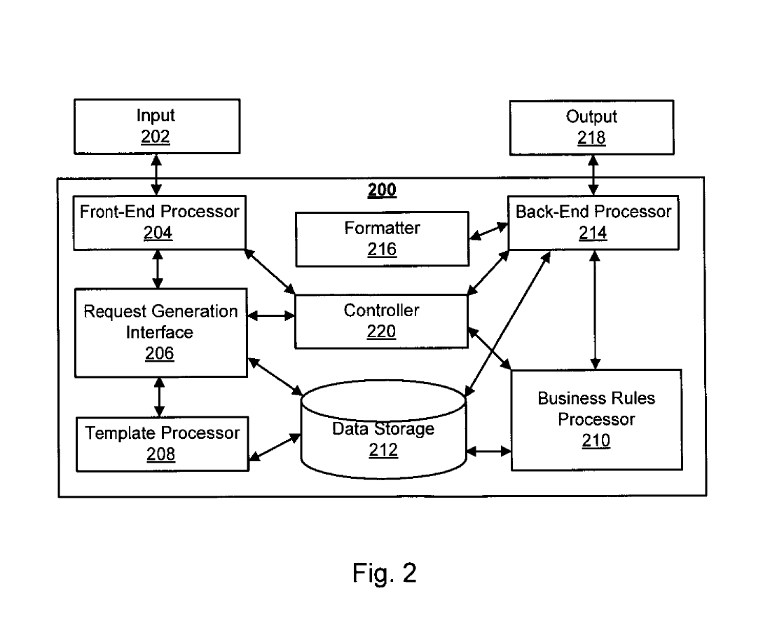

FIG. 2 depicts a block diagram of a system architecture for providing an automatic generation of a service request, according to an exemplary embodiment. Referring to FIG. 2, the system architecture 200 for providing an automatic generation of a service request may include an input 202, a front-end processor or module 204, a request generation interface 206, a template processor or module 208, a business rules processor or module 210, a data storage unit 212, a back-end processor or module 214, a formatter 216, an output 218, and a controller 220, all of which may be communicatively coupled to one another within the system architecture 200.

The front-end processor or module 204 may also receive information about an order for which an ASR may be required to be sent. The front-end processor or module 204 may receive information required to form a service request from the input 202.

The request generation interface 206 may be a graphical user interface (“GUI”) with which one or more analysts or operators (e.g., a business analyst or operator) may interact. For example, after logging into the request generation interface 206, the analyst or operator may interact with the request generation interface 206 to create one or more templates. The one or more templates may be created based on a variety of elements, such as service provider, ordered service, forms, fields, or other element. Once the analyst or operator selects a service provider, for example, the analyst or operator may enter one or more service configurations. The analyst or operator may also set one or more required forms that are required for a service configuration. The analyst or operator may also add, delete, or modify fields that should be present in the form. The business rules that need to be applied on the fields may also be set by the analyst or operator. For example, a transport point-to-point service may require an ASR form and a transport form. In this example, the analyst or operator may add one or more mandatory fields in the form for ordering this service. It should also be appreciated that data sources, which provide the data for these forms or fields, may also be set by the analyst or operator.

As shown below, Table 1 provides an exemplary list of forms for ASR 38.

TABLE 1
ASR 38 FORMS

| FORM | DESCRIPTION |
|---|---|
| ACI | Additional Circuit Information (ACI) Form |
| ARI | Additional Ring Information (ARI) Form |
| ASR | Access Service Request (ASR) |
| C/NR | Clarification/Notification Request (C/NR) Form |
| CN | Confirmation Notice (CN) Form |
| EOD | End Office Detail (EOD) Form |
| EUSA | End User Special Access Request (EUSA) Form |
| EVC | Ethernet Virtual Connection (EVC) Form |
| FGA | Feature Group A (FGA) Form |
| MSL | Multipoint Service Legs (MSL) Form |
| MULTI-EC | Multiple Exchange Company (Multi-EC) Form |
| NAI | Network Assignment Information (NAI) Form |
| OB | Open Billing (OB) Form |
| PC | Ports Configuration (PC) Form |
| RING | Ring Form |
| SALI | Service Address Location Information (SALI) Form |
| TQ | Transport Questionnaire (TQ) Form |
| TRANSPORT | Transport Form |
| TRUNKING | Trunking Form |
| TSR | Testing Services Request (TSR) Form |
| VC | Virtual Connection (VC) Form |
| VCAT | VCAT form |
| WAL | WATS Access Line (WAL) Form |

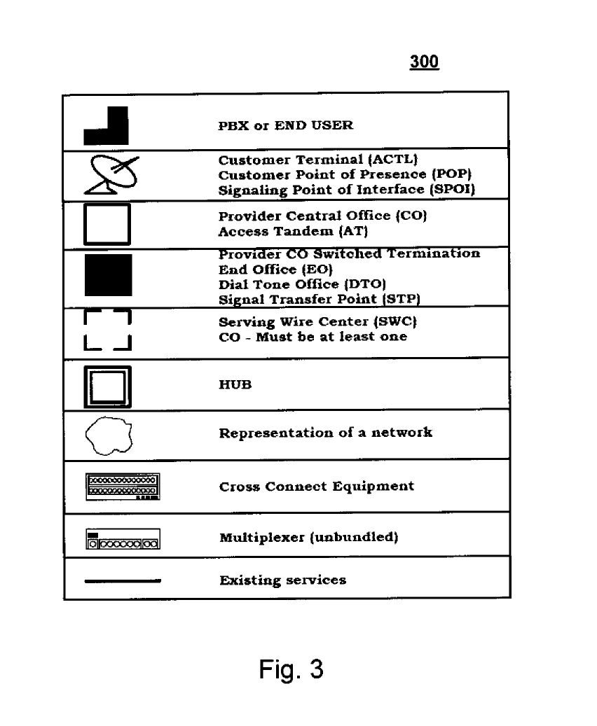

In some embodiments, the request generation interface 206 may include symbols, such as images, shortcut icons, or other similar identifier. These symbols may represent Point of Presence (“POP”), Central Office (“CO”), Serving Wire Center (“SWC”), or other representation. The analyst or operator may be able to represent the service configuration using one or more symbols. Some illustrative examples 300 of these one or more symbols are depicted in FIG. 3, according to an exemplary embodiment.

The template processor or module 208 may generate one or more templates based on data specified by the analyst or operator at the request generation interface 206. The template processor or module 208 may store the one or more templates in data storage 212.

The business rules processor or module 210 may apply one or more rules set by the analyst or operator at the request generation interface 206 while creating the one or more templates against data provided by the front-end processor or module 204 for the service order. It should be appreciated that as a quality control feature, a service request may be not be generated if the data does not conform to one or more of the business rules.

In some embodiments, the business rules processor or module 210 may be invoked by the back-end processor or module 214. The back-end processor or module 214 may be communicatively coupled to the business rules module 210. The back-end processor or module 214 may send one or more service requests to the output 218 (e.g., for use by an ILEC or CLEC). For example, the back-end processor or module 214 may be configured to transmit the service request to the service provider for ordering the telecommunications service. The back-end module may be further configured to invoke the business rules module to apply the one or more business rules.

The formatter 216 may format the created service request for optimal use at the output 218. For example, the service request may be formatted and sent in a variety of usable formats, such as extensible markup language (“XML”), electronic data/document interchange (“EDI”), or other format. In some embodiments, the formatter 216 may be communicatively coupled to the output 218 and may send the one or more service requests to the output 218.

In some embodiments, the controller 220 may be communicatively coupled to the front-end processor 204, the request generation interface 206, the business rules processor 210, and the back-end processor 214. The controller 220 may control request flow of a service order. For example, the controller 220 may call on one or more modules of system architecture 200 according to the state of the service order. For instance, the controller 220 may apply one or more business rules on the service order by calling the business rules processor 210 after receiving data through the front-end processor 204.

Other various embodiments and considerations may also be provided to optimize generation of service requests. It should be appreciated that while embodiments are primarily directed to ordering telecommunications service, other types of services may also be provided. It should also be appreciated that while embodiments are primarily directed to automatic generation of service requests, other types of generation may be provided. For example, generation may be facilitated manually by one or more customers, analysts, operators, or administrators. In other embodiments, generation of service requests may entirely automatic or may be a combination of manual and automatic generation.

While depicted as various servers, components, elements, or devices, it should be appreciated that embodiments may be constructed in software or hardware, as a separate or stand-alone device, or as part of an integrated transmission or switching device.

Additionally, it should also be appreciated that system support and updating the various components of the system may be achieved. For example, a system administrator may have access to one or more of the components of the system, network, components, elements, or device. It should also be appreciated that the one or more servers, components, elements, or devices of the system may not be limited to physical components. These components may be computer-implemented software-based, virtual, etc. Moreover, the various servers, components, elements, or devices may be customized to perform one or more additional features and functionalities. Such features and functionalities may be provided via deployment, transmitting or installing software or hardware.

It should also be appreciated that each of the communications devices, servers, modules, or network elements may include one or more processors. It should be appreciated that one or more data storage systems (e.g., databases) may also be coupled to each of the devices or servers of the system. In one embodiment, the one or more data storage systems may store relevant information for each of the servers and system components. It should also be appreciated that software may be implemented in one or more computer processors, modules, network components, services, devices, or other similar systems.

It should be appreciated that the contents of any of these one or more data storage systems may be combined into fewer or greater numbers of data storage systems and may be stored on one or more data storage systems or servers. Furthermore, the data storage systems may be local, remote, or a combination thereof to client systems, servers, or other system components. In another embodiment, information stored in the databases may be useful in providing additional personalizations and customizations.

By providing automatic generation of service requests, ordering services may be achieved more efficiently, accurately, and comprehensively. Cost synergies, bulk application, and streamline generation may also be achieved.

It should be appreciated that the system 100 of FIG. 1 and the system 200 of FIG. 2 may be implemented in a variety of ways. The architectures 100 and 200 may be implemented as a hardware component (e.g., as a module) within a network element or network box. It should also be appreciated that the architectures 100 and 200 may be implemented in computer executable software. Although depicted as a single architecture, module functionality of the architectures 100 and 200 may be located on a single device or distributed across a plurality of devices including one or more centralized servers and one or more pieces of customer premises equipment or end user devices.

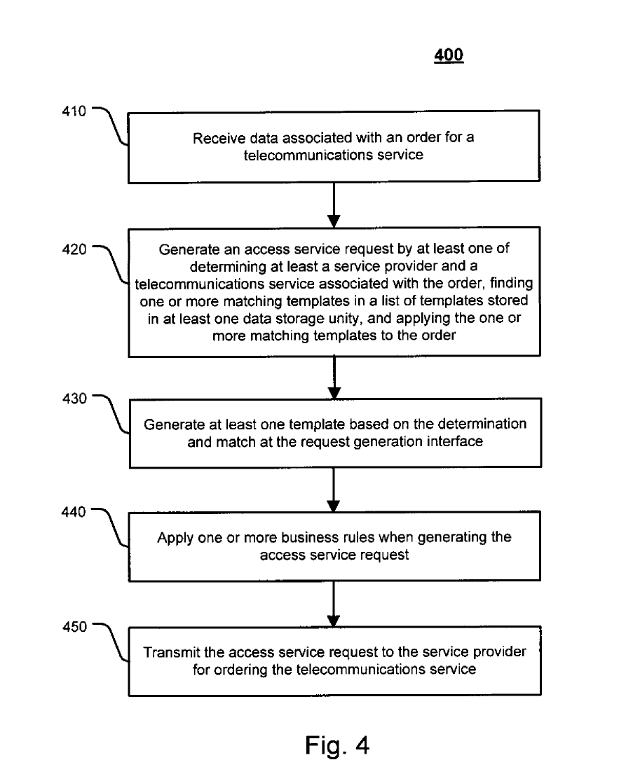

FIG. 4 depicts an illustrative flowchart of a method for providing an automatic generation of a service request, according to another exemplary embodiment. The exemplary method 400 is provided by way of example, as there are a variety of ways to carry out methods disclosed herein. The method 400 shown in FIG. 4 may be executed or otherwise performed by one or a combination of various systems. The method 400 is described below as carried out by at least system 100 in FIG. 1 and system 200 in FIG. 2, by way of example, and various elements of systems 100 and 200 are referenced in explaining the exemplary method of FIG. 4. Each block shown in FIG. 4 represents one or more processes, methods, or subroutines carried in the exemplary method 400. A computer readable medium comprising code to perform the acts of the method 400 may also be provided. Referring to FIG. 4, the exemplary method 400 may begin at block 410.

At block 410, the front-end module 204 of FIG. 2 may be configured to receive data associated with an order for a telecommunications service.

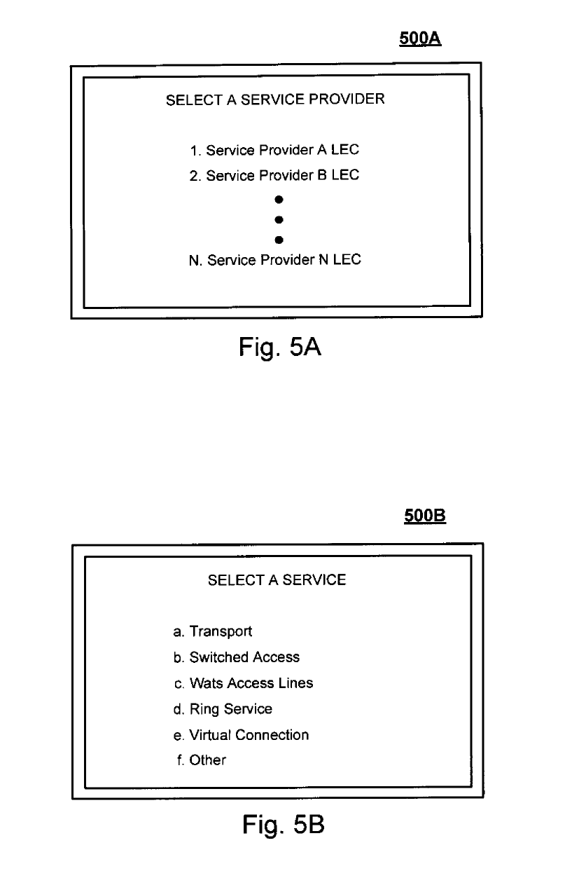

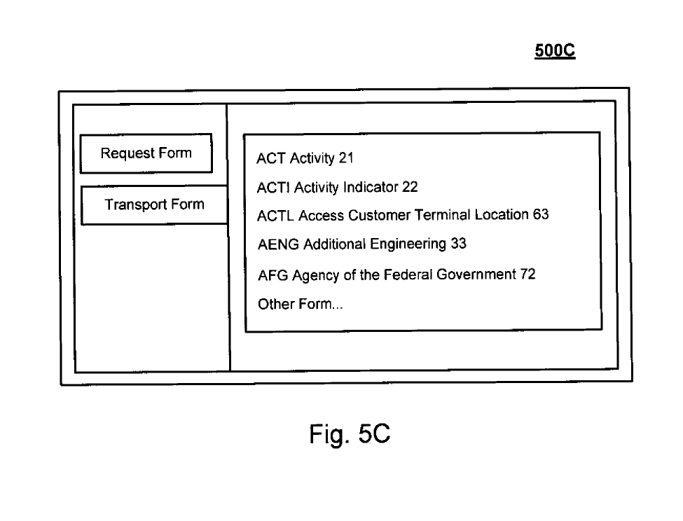

At block 420, the request generation interface 206 of FIG. 2, which may be communicatively coupled to the front-end module 204, may be configured to generate a service request. FIGS. 5A-5C depict illustrative screens for providing an automatic generation of a service request at the request generation interface 206, according to another exemplary embodiment.

A service request may be generated by determining at least a service provider and a telecommunications service associated with the order. In FIG. 5A, an exemplary screen for selecting a service provider 500A is shown. In this example, an analyst, operator, or a processor configured to automatic selection may select multiplicity of service providers (e.g., Service Provider A LEC, Service Provider B LEC, . . . N Service Provider). In other words, the analyst, operator, or processor may select a service provider from a list of many service providers. The service provider may be an incumbent local exchange carriers (“ILEC”), a competitive local exchange carrier (“CLEC”), an interexchange carrier (“IXC”), or other service provider.

In FIG. 5B, an exemplary screen for selecting a telecommunications service 500B is shown. In this example, the telecommunications service may comprise at least one of a transport service, switched access service, Wide-Area Telephone Service (“Wats”) access service, ring service, a virtual connection, or other telecommunications service. These services may provide one or more of a broadband service, a multimedia-related service, a high-capacity circuit, an optical circuit, an asynchronous transfer mode circuit, a frame relay circuit, a voice service, and access service to public switched telephone network (PSTN).

The service request generation may also comprise finding a one or more matching templates in a list of templates stored in at least one data storage unit 212 and may apply the one or more matching templates to the order.

It should be appreciated that the service request that is generated may be an access service request (ASR), a local service request (LSR), or other similar request for service. The service request may conform to standard order guidelines, e.g., the access services order guidelines (ASOG).

At block 430, the template module 208 of FIG. 2, which may be communicatively coupled to the request generation interface 206 and the at least one data storage unit 212, may be configured to generate at least one template based on the determination and match at the request generation interface 206. If no match is found, a template may be created. When the telecommunications service and the service provider are selected, the request generation interface may automatically populate one or more forms along with the required fields. In FIG. 5C, an exemplary screen of forms associated with the selected service provider and the selected telecommunications service may be presented. In this example, all required forms and corresponding fields may be populated based on the order data. In some embodiments, other forms may be added, deleted, or modified according to other specifications or needs of service provider. It should be appreciated that once the forms are populated, all required fields may be populated in the forms by the system 200. At this point, an analyst, operator, or processor may map the order data (e.g., from one or more sources) to populate the field. Moreover, the analyst, operator, or processor may configure one or more business rules in the business rules module 210 to validate these fields. Accordingly, a template may be generated based on the selected service provider, ordered service, forms, and fields. This template may be stored in the data storage unit 212 and may be applied to one or more service requests for processing and transmission to the service provider.

At block 440, the business rules module 210 of FIG. 2, which may be communicatively coupled to the request generation interface 206 and the at least one data storage unit 212, may be configured to apply one or more business rules when generating the service request.

At block 450, the back-end module 214 of FIG. 2, which may be communicatively coupled to the business rules module 210, may be configured to transmit the service request to the service provider for ordering the telecommunications service. The back-end module may be further configured to invoke the business rules module to apply the one or more business rules. The formatter 216 of FIG. 2, which may be communicatively coupled to the back-end module 214, may be configured to format the service request in a usable format (e.g., XML or EDI) for the service provider.

It should be appreciated that the set of instructions, e.g., the software, that configures the computer operating system to perform the operations described above may be contained on any of a wide variety of media or medium, as desired. Further, any data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by a computer.

In summary, embodiments may provide a system and method for comprehensively and effectively providing automatic generation of a service request. It should be appreciated that although embodiments are described primarily with telecommunications service, the systems and methods discussed above are provided as merely exemplary and may have other various applications and implementations.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

We claim:

1. A system, comprising:
a front-end module configured to receive data associated with an order, wherein the order is for a telecommunications service;
a request generation interface communicatively coupled to the front-end module and configured to determine at least a service provider and a telecommunications service associated with the order, find a one or more matching templates in a list of templates stored in at least one data storage unit, apply the one or more matching templates to the order, and generate an access service request;
a template module communicatively coupled to the request generation interface and the at least one data storage unit, wherein the template module is configured to generate at least one template based on the step of determining or finding at the request generation interface;
a business rules module communicatively coupled to the request generation interface and the at least one data storage unit, wherein the business rules module is configured to apply one or more business rules when generating the access service request; and
a back-end module communicatively coupled to the business rules module and configured to transmit the access service request to the service provider for ordering the telecommunications service.

2. The system of claim 1, wherein the back-end module is further configured to invoke the business rules module to apply the one or more business rules.

3. The system of claim 1, further comprising a formatter communicatively coupled to the back-end module and configured to format the access service request in a usable format for the service provider.

4. The system of claim 3, wherein the usable format comprises at least one of an extensible markup language (XML) and electronic data/document interchange (EDI).

5. The system of claim 1, wherein the telecommunications service comprises at least one of a transport service, switched access service, Wats access service, ring service, and a virtual connection.

6. The system of claim 1, wherein the service provider comprises at least one of an incumbent local exchange carriers (ILEC), a competitive locan exchange carrier (CLEC), and an interexchange carrier (IXC).

7. The system of claim 1, wherein the service request conforms to standard order guidelines.

8. The system of claim 7, wherein the standard order guidelines are the access services order guidelines (ASOG).

9. The system of claim 1, wherein when one of the telecommunications service and the service provider is selected, the request generation interface automatically populates one or more forms along with the required fields.

10. A method, comprising:
receiving, at a front-end module, data associated with an order, wherein the order is for a telecommunications service;
generating, at a request generation interface, an access service request, by at least one of determining at least a service provider and a telecommunications service associated with the order, finding one or more matching templates in a list of templates stored in at least one data storage unit, and applying the one or more matching templates to the order;
generating, at a template module, at least one template based on the step of determining and finding at the request generation interface;
applying, by a business rules module, one or more business rules when generating the access service request; and
transmitting, by a back-end module, the access service request to the service provider for ordering the telecommunications service.

11. The method of claim 10, wherein the back-end module is further configured to invoke the business rules module to apply the one or more business rules.

12. The method of claim 10, further comprising a formatter communicatively coupled to the back-end module and configured to format the access service request in a usable format for the service provider.

13. The method of claim 12, wherein the usable format comprises at least one of an extensible markup language (XML) and electronic data/document interchange (EDI).

14. The method of claim 10, wherein the telecommunications service comprises at least one of a transport service, switched access service, WATS access service, ring service, and a virtual connection.

15. The method of claim 10, wherein the service provider comprises at least one of an incumbent local exchange carriers (ILEC), a competitive locan exchange carrier (CLEC), and an interexchange carrier (IXC).

16. The method of claim 10, wherein the access service request conforms to standard order guidelines.

17. The method of claim 16, wherein the standard order guidelines are the access services order guidelines (ASOG).

18. The method of claim 11, wherein when one of the telecommunications service and the service provider is selected, the request generation interface automatically populates one or more forms along with the required fields.

19. A computer readable medium comprising code to perform the acts of the method of claim 10.
